(19) United States
(12) Patent Application Publication
(10) Pub. No.: US 2024/0181655 A1
(43) Pub. Date: Jun. 6, 2024

(54) VARIABLE FRICTION FINGER ASSEMBLY

(71) Applicant: Ocado Innovation Limited, Hatfield, Hertfordshire (GB)

(72) Inventors: Jan FRAS, Hatfield, Hertfordshire (GB); Panagiotis SOTIROPOULOS, Hatfield, Hertfordshire (GB); Hussein MNYUSIWALLA, Hatfield, Hertfordshire (GB); Enrique DEL SOL ACERO, Hatfield, Hertfordshire (GB); Pavlos TRIANTAFYLLOU, Hatfield, Hertfordshire (GB)

(73) Assignee: Ocado Innovation Limited, Hatfield, Hertfordshire (GB)

(21) Appl. No.: 18/553,358

(22) PCT Filed: Mar. 31, 2022
(86) PCT No.: PCT/EP2022/058674

§ 371 Date: Sep. 29, 2023

(30) Foreign Application Priority Data
Mar. 31, 2021 (GB) 2104577.8

(51) Int. Cl. B25J 15/00; B25J 15/08

(52) U.S. Cl. CPC B25J 15/0023; B25J 15/08

(57) ABSTRACT

This disclosure relates to a finger assembly for a manipulating apparatus. The finger includes a rigid body having a surface configured to engage an object. The surface has a first coefficient of friction, apertures, and an inflatable element received within the rigid body, having a coefficient of friction which is greater than the first coefficient of friction. When the inflatable element is inflated, regions of the inflatable element form one or more protrusions by protruding through the one or more apertures.

This invention relates generally to the field of finger assemblies for a manipulating apparatus, and more specifically to finger assemblies which can have variable coefficients of friction.

### BACKGROUND

Automated picking systems require robotic picking stations which are able to select an item from a first receptacle, such as a tote or other storage unit, grip the item, and then move the item into a second receptacle, such as a bag. When manipulating items, it is beneficial for the finger assemblies of the manipulating apparatus to have a low friction when manoeuvring the finger assembly into contact such that the item can be grasped. However, when gripping the item, for example in order to lift it, it is beneficial for the finger assembly to have a high friction.

Spiers et al ‘Variable-Friction End effector Surfaces to Enable Within-Hand Manipulation via Gripping and Sliding’, pp 4116-4123, IEEE Robotics and Automation Letters, vol. 3, no. 4, October 2018 disclose an end effector in which a low friction surface can be moved relative to a high friction surface. In operation, the low friction surface slides over the surface of an object to be gripped and then the high friction surface is used for gripping the object.

It is against this background that the invention has been devised.

### SUMMARY

Accordingly, the invention provides a finger assembly for a manipulating apparatus which has a low friction surface in a passive state and a high friction surface in an active state. In general terms, the invention introduces a finger assembly comprising a rigid body within which is received an inflatable element. The rigid body has a low friction gripping surface and one or more apertures formed within the low friction gripping surface. In the active state, pressure in the finger element may be increased such that regions of the inflatable element protrude through the one or more apertures. The protrusions have a high friction and enable an object to be gripped by two opposed finger assemblies.

Accordingly, the invention provides, a first aspect, a finger assembly for a manipulating apparatus, the finger assembly comprising: a rigid body, wherein the rigid body has a first coefficient of friction and comprises a surface configured to engage an object, the surface comprising one or more apertures; and an inflatable element received within the rigid body, the inflatable element having a coefficient of friction which is greater than the first coefficient of friction; wherein, when the inflatable element is inflated, regions of the inflatable element form one or more protrusions by protruding through the one or more apertures.

A mesh may be formed on a surface of the inflatable element. The mesh may be formed on the surface of the inflatable element which forms the one or more protrusions. The application of the mesh may increase the stability of the protrusions when the inflatable element is inflated and increase the physical durability and resilience of the inflatable element.

The rigid body may comprise a rear surface which is in opposition to the surface configured to engage an object and one or more reinforcement elements which connect the rear surface to the surface configured to engage an object. The reinforcement elements increase the rigidity of the finger assembly and reduce the risk that the inflation of the inflatable element leads to the finger assembly becoming distorted, for example by causing the gripping surface to bend.

At least one of the one or more apertures is substantially circular. Alternatively, at least one of the one or more apertures may be substantially elongate. Alternatively, in embodiments comprising a plurality of apertures, one of the plurality of apertures may be substantially circular, whereas another of the plurality of apertures may be substantially elongate. That is, the finger assembly may comprise apertures of different shapes and/or sizes. The finger assembly may comprise an actuator which, in use, can be activated to move the finger assembly. The actuator may move the finger assembly in multiple axes of movement and may be used to rotate the actuator about multiple axes of rotation.

According to a second aspect of the invention there is provided a manipulating apparatus comprising a first finger assembly according to the first aspect opposing a second finger assembly according to the first aspect and a controller, the controller being configured to move the first finger assembly relative to the second finger assembly to engage an object and inflate the inflatable elements of the first and second finger assemblies during the engagement of the object by the first and second finger assemblies.

The controller may be configured to cause the inflatable element of the first finger assembly and the inflatable element of the second finger assembly to be inflated in accordance with the location of the first finger assembly and the second finger assembly relative to the object. The controller may be configured to cause the inflatable element of the first finger assembly and the inflatable element of the second finger assembly to be inflated when the first and second finger assemblies are moved into proximity with the object. The controller may be configured to cause the inflatable element of the first finger assembly and the inflatable element of the second finger assembly to be inflated when the first and second finger assemblies are moved into contact with the object.

The degree of inflation applied to the inflatable element of the first finger assembly and the inflatable element of the second finger assembly may be varied. The degree of inflation applied may be controlled to vary the height of the protrusions relative to the surface configured to engage an object.

According to a third aspect of the invention there is provided a method of manipulating an object, the method comprising the steps of: a) moving a first finger assembly according to the first aspect relative to a second finger assembly according to the first aspect to engage an object; b) inflating the inflatable element of the first finger assembly and the inflatable element of the second finger assembly; c) engaging the object with the first and the second finger assemblies; and, d) manipulating the object. The method may comprise the further steps of: e) deflating the inflatable element of the first finger assembly and the inflatable element of the second finger assembly; and, f) disengaging at least one of the first or second finger assemblies from the object.

### BRIEF DESCRIPTION OF THE DRAWINGS

These and other aspects of the invention will now be described by way of example only with reference to the accompanying drawings, in which:

FIG. 1 shows a schematic depiction of a manipulating apparatus according to an embodiment of the invention;

FIG. 2 shows a schematic depiction of a finger assembly for use with the manipulating apparatus of FIG. 1;

FIG. 3 shows a schematic depiction of a gripping surface of the finger assembly of FIG. 2;

FIG. 4 shows a schematic depiction of an inflatable element of the finger assembly of FIG. 2;

FIG. 5 shows a schematic depiction of a cross-section of the finger assembly of FIG. 2 parallel to the gripping surface;

FIGS. 6 to 8 show schematic depictions of a cross-section of the finger assembly of FIG. 2 orthogonal to the gripping surface;

FIGS. 9 and 10 show a schematic side view of the finger assembly of FIG. 2;

FIG. 11 shows a schematic depiction of a cross-section of an alternative embodiment of a finger assembly according to the invention parallel to the gripping surface;

FIG. 12 shows a schematic depiction of an inflatable element of the finger assembly of FIG. 11;

FIG. 13 shows a schematic depiction of a gripping surface of the finger assembly of FIG. 11; and,

FIG. 14 shows a schematic side view of the finger assembly of FIG. 11.

In the drawings, like features are denoted by like reference signs where appropriate.

### DETAILED DESCRIPTION

In the following description, some specific details are included to provide a thorough understanding of the disclosed examples. One skilled in the relevant art, however, will recognise that other examples may be practiced without one or more of these specific details, or with other components, materials, etc., and structural changes may be made without departing from the scope of the invention as defined in the appended claims. Moreover, references in the following description to any terms having an implied orientation are not intended to be limiting and refer only to the orientation of the features as shown in the accompanying drawings. In some instances, well-known features or systems, such as processors, sensors, storage devices, network interfaces, fasteners, electrical connectors, and the like are not shown or described in detail to avoid unnecessarily obscuring descriptions of the disclosed embodiment.

Unless the context requires otherwise, throughout the specification and the appended claims, the word “comprise” and variations thereof, such as, “comprises” and “comprising” are to be construed in an open, inclusive sense that is as “including, but not limited to.”

Reference throughout this specification to “one”, “an”, or “another” applied to “embodiment”, “example”, means that a particular referent feature, structure, or characteristic described in connection with the embodiment, example, or implementation is included in at least one embodiment, example, or implementation. Thus, the appearances of the phrase “in one embodiment” or the like in various places throughout this specification are not necessarily all referring to the same embodiment. Furthermore, the particular features, structures, or characteristics may be combined in any suitable manner in one or more embodiments, examples, or implementations.

It should be noted that, as used in this specification and the appended claims, the users forms “a”, “an”, and “the” include plural referents unless the content clearly dictates otherwise. It should also be noted that the term “or” is generally employed in its sense including “and/or” unless the content clearly dictates otherwise.

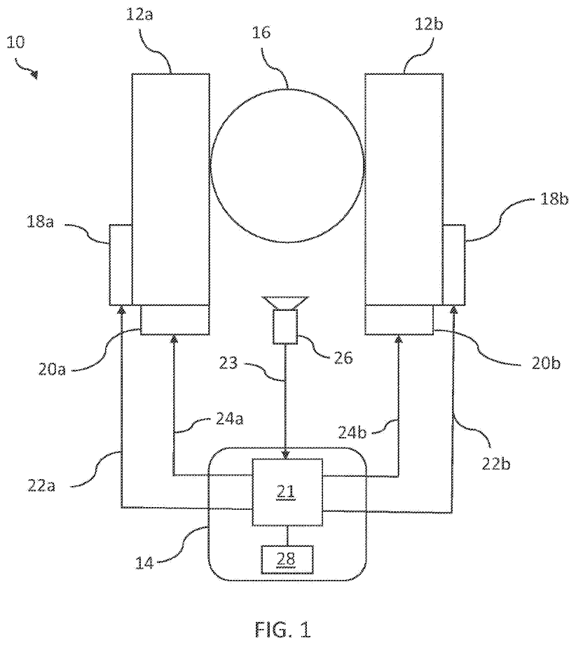

FIG. 1 shows a schematic depiction of a manipulating apparatus 10 according to an embodiment of the invention comprising a first finger assembly 12a opposing a second finger assembly 12b, and a controller 14. Each one of the first and second finger assemblies 12a, 12b includes an inflatable element (not shown in FIG. 1), an exterior surface of which comprises a gripping surface arranged to grip an object 16 to be manipulated. The manipulating apparatus 10 further comprises a first actuator 18a and a first pressure regulating means 20a, both of which are associated with the first finger assembly 12a, and a second actuator 18b and a second pressure regulating means 20b associated with the second finger assembly 12b. The first and second pressure regulating means 20a, 20b are connected to their associated finger assembly 12a, 12b by respective pressure lines 27a, 27b and other suitable connectors. The controller 14 comprises an electronic processor 21 having one or more electrical inputs for receiving an input signal, such as, for example, a visual data input signal 23 from an optical sensor 26 that forms part of the manipulating apparatus 10, and one or more electrical outputs for outputting one or more control signals 22a, 22b, 24a, 24b to the first and second actuators and pressure regulating means 18a, 18b, 20a, 20b in dependence on the visual data input signals 23a, 23b. For example, the controller 14 is configured to output a first actuation control signal 22a for moving the first finger assembly 12a based on the visual data input signal 23. The first actuator 18a is configured to receive the first actuation control signal 22a and move the first finger assembly 12a relative to the second finger assembly 12b in dependence on the first actuation control signal 22a. Similarly, the controller 14 may also output a second actuation control signal 22b for moving the second finger assembly 12b based on the visual data input signal 23. The second actuator 18b is configured to receive the second actuation control signal 22b and move the second finger assembly 12b relative to the first finger assembly 12a in dependence on the second actuation control signal 22b. These movements may be about multiple axes of movement and include rotation of one of the first or second finger assembly 12a, 12b relative to the other of the first or second finger assembly 12a, 12b. Such movement may allow the object 16 to be gripped between the first and second finger assemblies 12a, 12b. The first and second finger assemblies 12a, 12b may also be movable together such that the object 16 gripped therebetween can be moved from a first location to a second location. The controller 14 is further configured to output inflation control signals 24a, 24b, in dependence on the visual data input signal 23 to control the first or second pressure regulating means 20a, 20b in order to alter the pressure in the interior of the first or second finger elements 12a, 12b so as to change the compliance of their respective inflatable element. Specifically, the controller 14 is arranged to output a first inflation control signal 24a based on the visual data input signal 23, and the first pressure regulating means 20a is configured to receive the first inflation control signal 24a and pressurise the first finger assembly 12a in dependence on the first inflation control signal 24a. Similarly, the controller 14 is arranged to output a second inflation control signal 24b based on the visual data input signal 23, and the second pressure regulating means 20b is configured to receive the second inflation control signal 24b and pressurise the second finger assembly 12b in dependence on the second inflation control signal 24b in order to alter the compliance of its inflatable element. In order to generate the control signals 22a, 22b, 24a, 24b, the controller 14 further comprises a memory device 28 electrically coupled to the electronic processor 21 and having instructions stored therein. The electronic processor 21 is configured to access the memory device 28 and execute the instructions stored thereon so as to carry out the foregoing processes.

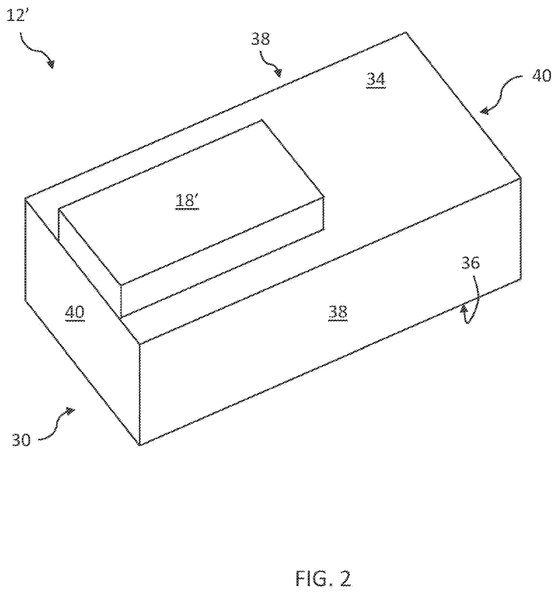

FIGS. 2 to 10 show schematic depictions of a finger assembly 12′ according to an embodiment of the invention, which is suitable for use in the manipulating apparatus 10. The finger assembly 12′ comprises a rigid body 30 in which is received an inflatable element.

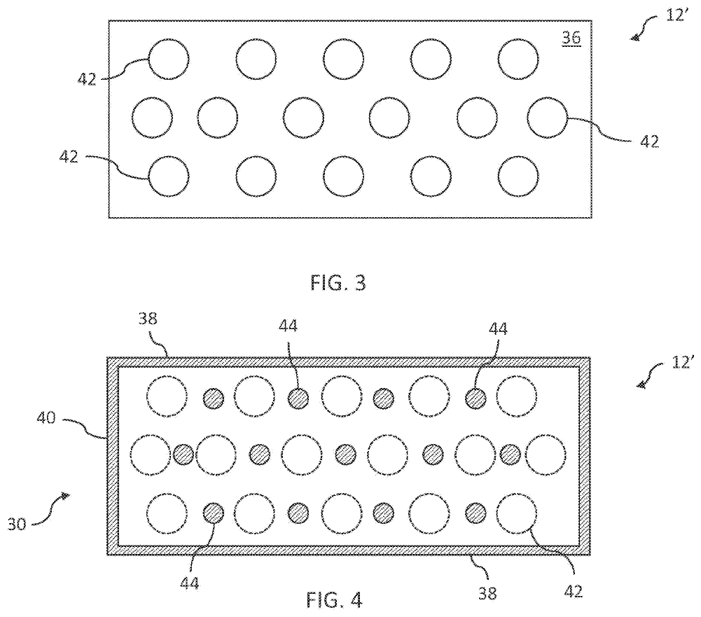

Referring to FIG. 2, which shows a schematic depiction of a perspective view of the finger assembly 12′, the rigid body 30 is substantially cuboidal and comprises a rear surface 34 on which an actuator 18′ is received. The rigid body 30 further comprises a gripping surface 36 (not shown in FIG. 2) which is opposed to the rear surface 34. The gripping surface 36 is configured to engage an object 16 to be manipulated and is connected to the rear surface 34 by two side faces 38 and two end faces 40. FIG. 3 shows a view of the gripping surface 36 comprising one or more apertures 42. In this embodiment, the gripping surface 36 comprises a plurality of apertures 42.

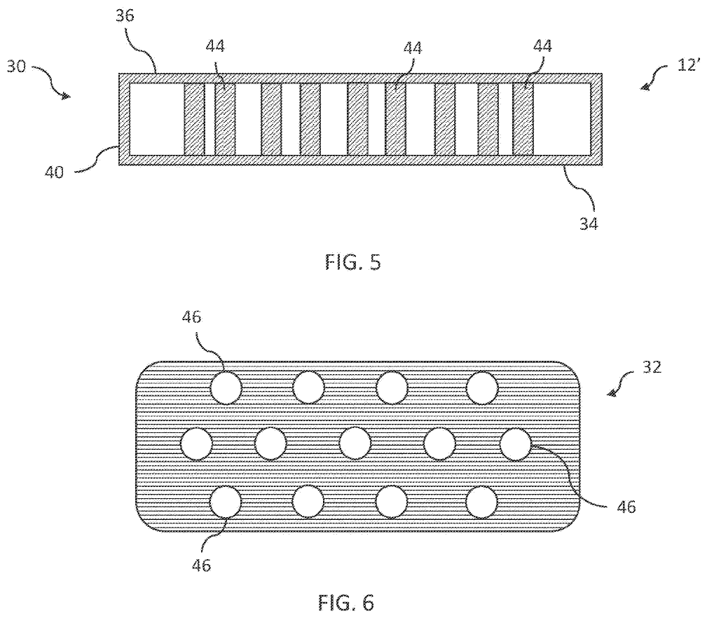

FIGS. 4 and 5 show schematic depictions of cross-sections of the rigid body 30. FIG. 4 shows a cross-section of the rigid body 30 on a plane which is parallel to and between the rear and gripping surfaces 34, 36. It can be seen from this figure that the rigid body 30 comprises a plurality of reinforcement elements 44, which in this embodiment comprise a plurality of columns 44. The plurality of columns 44 extend between and connect the rear and gripping surfaces 34, 36, increasing the rigidity of the rigid body 30. FIG. 4 illustrates the position of the plurality of apertures 42, formed within the gripping surface 36, relative to the position of the plurality of columns 44, with the plurality of apertures 42 being shown by dotted lines. It can be seen that the plurality of columns 44 are arranged such that they are not located underneath one of the plurality of apertures 42. FIG. 5 shows a cross-section of the finger assembly 12′ on a plane which is orthogonal to the gripping surface 36 (and also the rear surface 34), showing the connection of the gripping surface 36 to the rear surface 34 by the plurality of columns 44.

FIG. 6 shows a schematic depiction of the inflatable element 32 comprising a plurality of openings 46. The plurality of openings 46 are positioned such that they align with the plurality of columns 44 formed within the rigid body 30 when the inflatable element 32 is received within the rigid body 30. The material(s) which comprise the rigid body 30 have a first coefficient of friction and the material(s) which comprise the inflatable element 32 have a second coefficient of friction, wherein that the second coefficient of friction is greater than the first coefficient of friction.

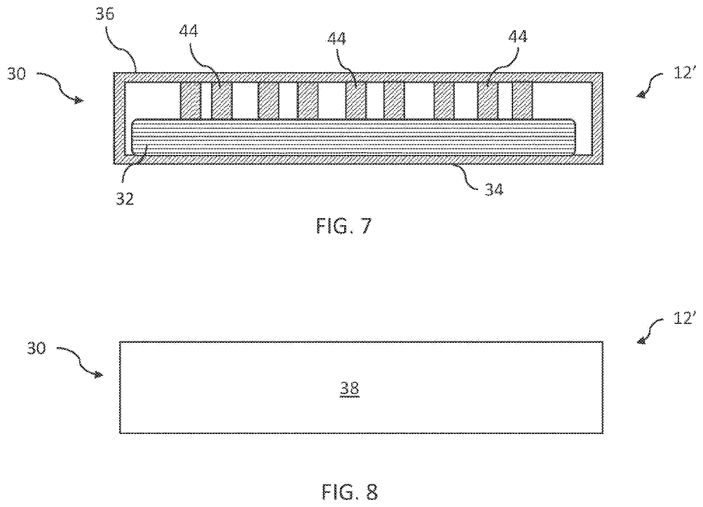

FIG. 7 shows the schematic depiction of the cross-sectional view of FIG. 5 in which the inflatable element 32 is received within the rigid body 30, such that each of the plurality of columns 44 is received within a respective opening of the plurality of openings 46 formed within the inflatable element 32. The size, that is the diameter, of the openings 46 is greater than the size of the columns 44 such that there it is possible for the inflatable element 32 to move relative to the plurality of columns 44. In other embodiments, the size of the openings and columns 46, 44 are substantially the equal, minimising relative movement therebetween, and so reducing any resulting wear and tear. FIG. 7 shows the inflatable element 32 when it is in an uninflated or inactive state, and FIG. 8 shows the external side view of the finger assembly 12′ when the inflatable element 32 is in the uninflated state. In an alternative embodiment, the inflatable element 32 may substantially occupy the entire volume of the rigid body 30 in its uninflated state and comprise a plurality of extrusions positioned to coincide with the position of the plurality of opening 46. The extrusions are arranged such, when the inflatable element 32 is uninflated, that their end surfaces and the gripping surface 36 of the rigid body 30 substantially align in the same plane. This arrangement allows the extrusions to engage an object 16 with little deformation of the inflatable element 32, meaning that the inflatable element 32 can be pressurised less when compared to the current embodiment.

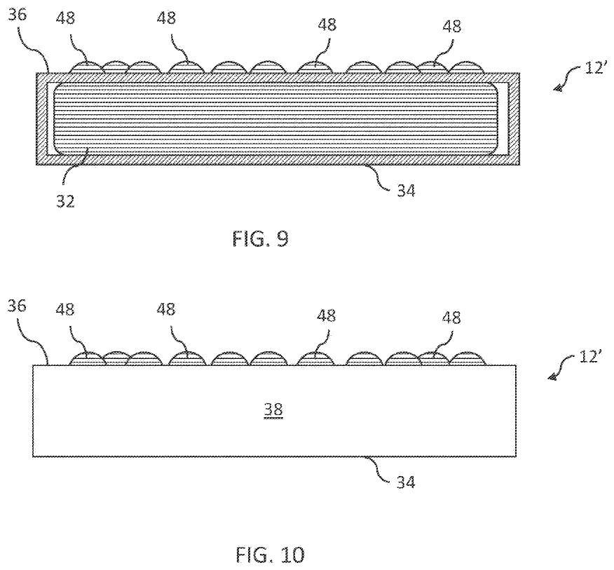

In use, the inflatable element 32 is inflated by a pressure regulating means 20′, according to an inflation control signal 24′, such that it expands and portions of the inflatable element 32 extend through the plurality of apertures 42 formed within the gripping surface 36. FIG. 9 shows the cross-sectional view of the finger assembly 12′ when the inflatable element 32 is in an inflated state (or active state) inside the interior of the rigid body 30. When the inflatable element 32 is in this state, a plurality of protrusions 48 are formed, with the diameter and the location of the protrusions 48 being limited by the size and location of the apertures 42 formed within the gripping surface 36. FIG. 10 shows the exterior side view of the finger assembly 12′ when the inflatable element 32 is in the inflated state and shows the plurality of protrusions 48 of the inflatable element 32 above the gripping surface 36.

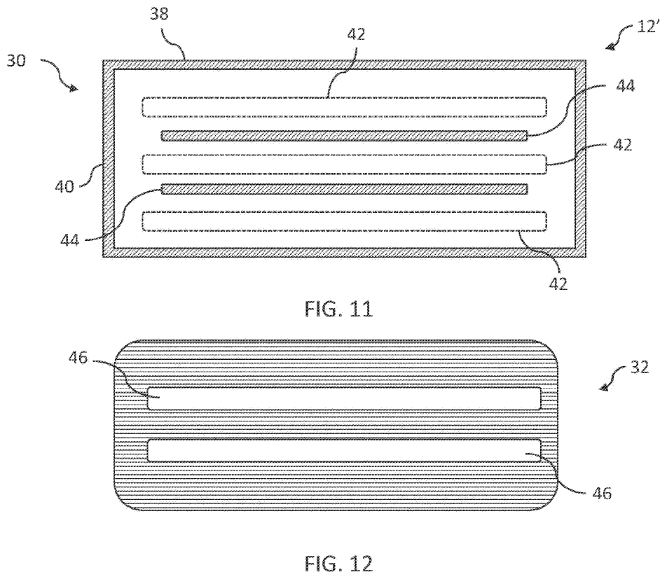

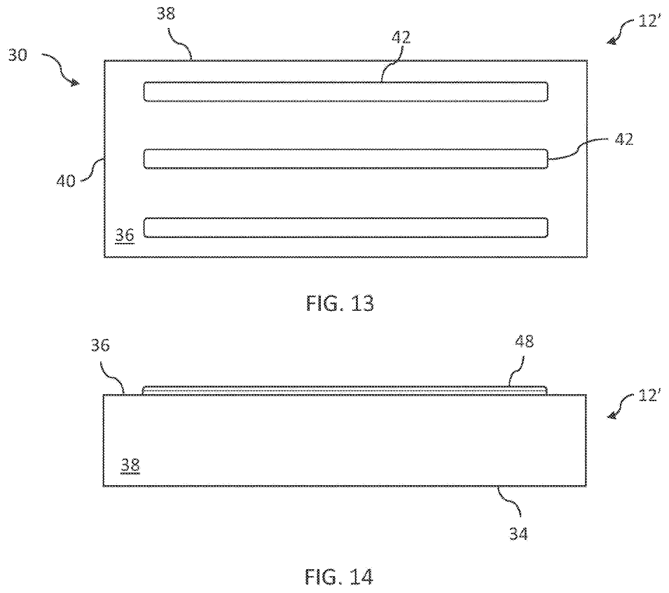

FIGS. 11 to 14 show schematic depictions of an alternative example of a finger assembly 12′ suitable for use in the manipulating apparatus 10. The finger assembly 12′ is as described above with reference to FIGS. 2 to 10 except that the gripping surface 36 of the rigid body 30 comprises three elongate apertures 42 and the reinforcement elements 44 comprise two elongate supports. Consequently, the inflatable element 32 comprises two elongate apertures 46 having a size and a location within the inflatable element 32 so as to allow the inflatable element 32 to be received within the rigid body 30. As described above, when the inflatable element 32 is in the uninflated state, the inflatable element 32 is completely received within the interior of the rigid body 30. When the inflatable element 32 is inflated, then portions of the inflatable element 32 may protrude through the elongate apertures 42 in the gripping surface 36, forming the plurality of protrusions 48. In this example, the protrusions 48 will comprise three linear protrusions extending along a portion of the length of the gripping surface 36.

The rigid body 30 may be formed by additive manufacturing, injection moulding or other conventional machining techniques. As mentioned above, the reinforcement elements 44 connect the rear and gripping surfaces 34, 36, increasing the rigidity of the rigid body 30 and reducing any deformation of the gripping surface 36 when the inflatable element 32 is inflated. The reinforcement elements 44 also act to restrict the movement of the inflatable element 32 when inflated. The rigid body 30 may be formed in two halves, which may be connected to each other to surround the inflatable element 32. The inflatable element 32 preferably comprises a single inlet through which it can be inflated, providing a fluid connection with the interior of the inflatable element 32 and a respective pressure line 27′. The inflatable element 32 may be formed from a flexible silicon material. The inflatable element 32 may be formed from two layers or a flexible silicon material which may then be securely connected together, for example by the use of an adhesive. The inlet may be formed from a rigid silicone material which can accept a pressurised air supply. The pressure regulating means 20′ may be configured to deflate the inflatable element 32 such that in the uninflated state a partial vacuum exists in the inflatable element 32, ensuring that all of the inflatable element 32 is retracted within the rigid body 30. A mesh may be applied to the face of the inflatable element 32 which forms the protrusions 48 when inflated. The mesh reinforces the inflatable element 32, making it more resilient. The patterning of the mesh may also lead to a further increase in the coefficient of friction for the protrusions 48 formed when the inflatable element 32 is inflated. The mesh also reduces the amount by which the inflatable element 32 can be inflated and allows for higher pressures to be applied that, in turn, allows for higher gripping forces, and less compliance. In alternative embodiments, the mesh might be embedded in the inflatable element 32.

When the finger assemblies 12a, 12b are being manoeuvred so as to bring them into contact with an object 16 to be gripped, then it is preferable that the finger assemblies 12a, 12b have low friction while they are positioned against the object 16. Subsequently, it is preferable that the finger assemblies 12a, 12b have a high friction such that the object 16 can be gripped effectively and then manipulated, for example by picking up the object 16 and then moving it from a first location to a second location. It may be seen that the finger assemblies 12′ address this issue, as when the inflatable element 32 is in the uninflated state then the lower friction surface of the finger assemblies 12′ can be used to engage with an object 16. Once contact has been made, then the inflatable element 32 may be inflated, such that the higher friction inflated protrusions 48 grip the object 16 such that it can be manipulated. The higher friction of the inflated protrusions 48 enable a greater frictional force to be applied to the object 16. As the protrusions 48 are inflated, they will have a degree of pliability which may prevent the object 16 from being damaged by being gripped too tightly. Once the object 16 has been manipulated, for example the object 16 may be moved from a first location to a second location then the inflatable element 32 may be uninflated and the finger assemblies 12′ disengaged from the object 16.

The manipulating apparatus 10 may comprise contact sensors (not shown in FIG. 1) instead of or in addition to the optical sensor 26. The contact sensors detect when the gripping surface 36 of the first and second finger assemblies 12a, 12b are in contact with an object 16 and the output one or more signals to be received as input signals by the electronic processor 21 of the controller 14. The electronic processor 21 then outputs one or more inflation control signals 24′ to the pressure regulating means 20′ in dependence on the input signals to inflate the inflatable elements 32 when both the first and second finger assemblies 12a, 12b are in contact with an object 16. Alternatively or additionally, the manipulating apparatus 10 may comprise proximity sensors (not shown in FIG. 1) which detect when the gripping surfaces 36 of the first and second finger assemblies 12′ are within specified distance of an object 16. The output signals of the proximity sensors are then received as input signals by the electronic processor 21 of the controller 14, which then outputs one or more inflation control signals 24′ based on the input signals to the pressure regulating means 20′ to inflate the inflatable elements 32 when the first and second finger assemblies 12a, 12b are sufficiently close to the object 16 to be gripped. Outputs from both a proximity and contact sensors may be used to determine the inflation of the inflatable elements 32.

Many modifications and variations can be made to the embodiments described above, without departing from the scope of the present invention. Multiple levels of inflation of the inflatable elements 32 may be provided, such that the height of the protrusions 48 relative to the gripping surface 36 can be varied. This may allow for differing levels of gripping force to be applied, with the force being determined by the degree of inflation applied to the inflatable element 32. It should be understood that the number, size and shape of the apertures 42 formed in the gripping surface 36 may be varied. For example, some embodiments of the finger assembly 12′ may comprise a single aperture 42 in the gripping surface 36, which is comparatively larger than those used in finger assemblies 12′ comprising multiple apertures 42. For some applications, it may be preferred that protrusions 48 are activated in different regions of the gripping surface 36. In such cases, the finger assembly 12′ may comprise a plurality of inflatable elements 32, each of which can be independently inflated or uninflated in a controllable manner.

In one respect, the present invention relates to a finger assembly 12′ for use in a manipulating apparatus 10. In one state, the finger assembly 12′ has a low coefficient of friction, whilst in a second state the finger assembly 12′ has a relatively higher coefficient of friction. This is achieved by locating an inflatable element 32 within a rigid body 30, the rigid body 30 comprising one or more apertures 42. By inflating the inflatable element 32, portions of the inflatable element will protrude through the one or more of apertures 42, causing the finger assembly 12′ to have an increased coefficient of friction.

The foregoing description has been presented for the purpose of illustration only and is not intended to be exhaustive or to limit the invention to the precise embodiments disclosed. It will be appreciated that modifications and variations can be made to the described embodiments without departing from the scope of the invention as defined in the appended claims.

1. A finger assembly for a manipulating apparatus, the finger assembly comprising:
a rigid body, wherein the rigid body has a first coefficient of friction and includes a surface configured to engage an object, the surface including one or more apertures; and
an inflatable element received within the rigid body, the inflatable element having a coefficient of friction which is greater than the first coefficient of friction;
wherein, when the inflatable element is inflated, regions of the inflatable element form one or more protrusions by protruding through the one or more apertures.

2. A finger assembly according to claim 1, wherein a mesh is formed on a surface of the inflatable element.

3. A finger assembly according to claim 2, wherein the mesh is formed on the surface of the inflatable element which forms the one or more protrusions.

4. A finger assembly according to claim 1, wherein the rigid body comprises:
a rear surface which is in opposition to the surface configured to engage an object and one or more reinforcement elements which connect the rear surface to the surface configured to engage an object.

5. A finger assembly according to claim 1, wherein at least one of the one or more apertures is substantially circular.

6. A finger assembly according to claim 1, wherein at least one of the one or more apertures is substantially elongate.

7. A manipulating apparatus in combination with a finger assembly according to claim 1, the combination comprising:
a first finger assembly configured according to claim 1, opposing a second finger assembly configured according to claim 1; and
a controller, the controller being configured to move the first finger assembly relative to the second finger assembly to engage an object and inflate inflatable elements of the first and second finger assemblies during engagement of an object by the first and second finger assemblies.

8. A manipulation apparatus combination according to claim 7, wherein the controller is configured to cause the inflatable element of the first finger assembly and the inflatable element of the second finger assembly to be inflated in accordance with a location of the first finger assembly and the second finger assembly relative to an object.

9. A manipulating apparatus combination according to claim 8, wherein the controller is configured to cause the inflatable element of the first finger assembly and the inflatable element of the second finger assembly to be inflated when the first and second finger assemblies are moved into proximity with a object.

10. A manipulation apparatus combination according to claim 8, wherein the controller is configured to cause the inflatable element of the first finger assembly and the inflatable element of the second finger assembly to be inflated when the first and second finger assemblies are moved into contact with an object.

11. A manipulating apparatus combination according to claim 7, wherein the controller is configured to vary a degree of inflation applied to the inflatable element of the first finger assembly and the inflatable element of the second finger assembly.

12. A manipulating apparatus combination according to claim 11, wherein heights of the protrusions relative to the surface configured to engage an object varies with the degree of inflation applied.

13. A method of manipulating an object, the method comprising:
a) moving a first finger assembly relative to a second finger assembly to engage an object, each of the first and the second finger assemblies including:
a rigid body, wherein the rigid body has a first coefficient of friction and includes a surface configured to engage an object, the surface including one or more apertures; and
and inflatable element received within the rigid body, the inflatable element having a coefficient of friction which is greater than the first coefficient of friction;
wherein, when the inflatable element is inflated, regions of the inflatable element form one or more protrusions by protruding through the one or more apertures;
b) inflating the inflatable element of the first finger assembly and the inflatable element of the second finger assembly;
c) engaging the object with the first and second finger assemblies; and
d) manipulating the object.

14. A method according to claim 13, comprising:
e) deflating the inflatable element of the first finger assembly and the inflatable element of the second finger assembly; and
f) disengaging at least one of the first or second finger assemblies from the object.

15. A finger assembly according to claim 3, wherein the rigid body comprises:
a rear surface which is in opposition to the surface configured to engage an object and one or more reinforcement elements which connect the rear surface to the surface configured to engage an object.

16. A finger assembly according to claim 15, wherein at least one of the one or more apertures is substantially circular.

17. A finger assembly according to claim 16, wherein at least one of the one or more apertures is substantially elongate.

18. A manipulating apparatus in combination with a finger assembly according to claim 17, the combination comprising:
a first finger assembly configured according to claim 17, opposing a second finger assembly configured according to claim 17; and
a controller, the controller being configured to move the first finger assembly relative to the second finger assembly to engage an object and inflate inflatable elements of the first and second finger assemblies during engagement of an object by the first and second finger assemblies.

19. A manipulating apparatus combination according to claim 10, wherein the controller is configured to vary a degree of inflation applied to the inflatable element of the first finger assembly and the inflatable element of the second finger assembly.

20. A manipulating apparatus combination according to claim 19, wherein heights of the protrusions relative to the surface configured to engage an object varies with the degree of inflation applied.
